(19) United States
(12) Patent Application Publication
(10) Pub. No.: US 2017/0061315 A1
(43) Pub. Date: Mar. 2, 2017

(54) DYNAMIC PREDICTION AGGREGATION

(71) Applicant: SAS Institute Inc., Cary, NC (US)

(72) Inventors: Michael James Leonard, Cary, NC (US); Yung-Hsin Chien, Apex, NC (US); Pu Wang, Charlotte, NC (US); Yue Li, Cary, NC (US)

(73) Assignee: SAS Institute Inc., Cary, NC (US)

(21) Appl. No.: 15/146,697

(22) Filed: May 4, 2016

Related U.S. Application Data
(60) Provisional application No. 62/210,763, filed on Aug. 27, 2015.

(51) Int. Cl. G06N 7/00; G06F 17/30

(52) U.S. Cl. CPC G06N 7/005; G06F 17/30345

(57) ABSTRACT

Disclosed are methods, system, and computer program products useful for generating summary statistics for data predictions based on the aggregation of data from past time intervals. Summary statistics such as prediction standard errors, variances, confidence limits, and other statistical measures, may be generated in a way that preserves the basic distributional properties of the original data sets, to allow, for example, a reduction of the multiple data sets through the aggregation process, which may be useful for a prediction process, while determining statistical information for the predicted data.

### CROSS-REFERENCE TO RELATED APPLICATIONS

This application claims the benefit of and priority to U.S. Provisional Application 62/210,763, filed on Aug. 27, 2015, which is hereby incorporated by reference in its entirety.

### SUMMARY

In accordance with the teachings described herein, systems, methods, and computer program products are provided for dynamically aggregating multiple data sets and identifying a prediction based on the aggregated data. For example, the disclosed methods, system, and computer program products are useful for generating prediction statistics for the predictions of data for upcoming time period based on the aggregation of data from past time intervals, including prediction statistics such as prediction standard errors, variances, confidence limits, and other statistical measures, in a way that preserves the basic distributional properties of the original data sets. In this way, a reduction of the multiple data sets can be achieved through the aggregation process, while statistical information can be determined for the predicted data for upcoming time periods in order to provide a measure of confidence in the predicted data.

For example, disaggregate data sets may be generated and filtered to create a subset of the disaggregate data sets. Each disaggregate data set may include actual data corresponding to past measurements, as well as modeled data corresponding to data generated by a model, for example. The subset of the disaggregate data sets may be aggregated and a prediction based on the aggregated past data may be determined, such as a prediction based on the aggregated past data and/or a prediction based on the aggregated modeled data. The prediction of the aggregated data may be reconciled with the actual data and/or modeled data in order to determine prediction statistics for the prediction.

In a first aspect, systems are provided, such as systems for generating data predictions and prediction statistics associated with the data predictions. In one embodiment, a system of this aspect comprises one or more processors; a non-transitory computer readable storage medium positioned in data communication with the one or more processors and including instructions that, when executed by the one or more processors, cause the one or more processors to perform operations. For example, in a particular embodiment, the operations comprise identifying a plurality of data sets, such as where each data set includes previous data, modeled data, and one or more data set attributes; receiving a filter criterion for filtering the plurality of data sets based on the data set attributes; and filtering the plurality of data sets using the filter criterion to identify a filtered plurality of data sets, such as a filtered plurality of data sets that is a subset of the plurality of data sets, and where each filtered data set has one or more data set attributes that are associated with the filter criterion. Optionally, a filtered data set includes filtered previous data and filtered modeled data. Operations may further comprise identifying an aggregation type, such as an aggregation type that identifies how the filtered plurality of data sets are to be aggregated; and generating an aggregated data set, such as by aggregating the filtered plurality of data sets using the aggregation type. Optionally, the aggregated data set includes an aggregated previous data set and an aggregated modeled data set. Optionally, the aggregated previous data set is generated using the filtered previous data. Optionally, the aggregated modeled data set is generated using the filtered modeled data. Operations may further comprise generating an aggregate prediction using the aggregated data set; and reconciling the aggregate prediction and the aggregated modeled data set to determine prediction statistics for the aggregate prediction.

In another aspect, computer-program products are provided, such as a computer program product tangibly embodied in a non-transitory machine-readable storage medium and including instructions configured to cause a computing device to perform operations. For example, in an embodiment, a computer program product includes instructions that, when executed by a processor, cause the processor to perform the following operations identifying a plurality of data sets, such as plurality of data sets that include previous data, modeled data, and one or more data set attributes; receiving a filter criterion for filtering the plurality of data sets based on the data set attributes; filtering the plurality of data sets using the filter criterion to identify a filtered plurality of data sets that is a subset of the plurality of data sets, such as where each filtered data set has one or more data set attributes that are associated with the filter criterion, and such as where a filtered data that set includes filtered previous data and filtered modeled data; identifying an aggregation type, such as an aggregation type that identifies how the filtered plurality of data sets are to be aggregated; generating an aggregated data set, such as by aggregating the filtered plurality of data sets using the aggregation type, and where an aggregated data set includes an aggregated previous data set and an aggregated modeled data set, such as an aggregated previous data set that is generated using the filtered previous data, and an aggregated modeled data set that is generated using the filtered modeled data; generating an aggregate prediction using the aggregated data set; and reconciling the aggregate prediction and the aggregated modeled data set to determine prediction statistics for the aggregate prediction.

In another aspect, methods are provided, such as computer implemented methods. In an embodiment, a method of this aspect comprises identifying a plurality of data sets, such as a plurality of data sets that includes previous data, modeled data, and one or more data set attributes; receiving a filter criterion for filtering the plurality of data sets based on the data set attributes; filtering the plurality of data sets using the filter criterion to identify a filtered plurality of data sets that is a subset of the plurality of data sets, such as where each filtered data set has one or more data set attributes that are associated with the filter criterion, and where a filtered data set includes filtered previous data and filtered modeled data; identifying an aggregation type, such as an aggregation type that identifies how the filtered plurality of data sets are to be aggregated; generating an aggregated data set, such as by aggregating the filtered plurality of data sets using the aggregation type, where the aggregated data set includes an aggregated previous data set and an aggregated modeled data set, and where an aggregated previous data set is generated using the filtered previous data, and where an aggregated modeled data set is generated using the filtered modeled data; generating an aggregate prediction using the aggregated data set; and reconciling the aggregate prediction and the aggregated modeled data set to determine summary statistics for the aggregate prediction.

Various data is useful with the systems, methods, and computer program products described herein. For example, previous data may be a time series, such as a data set that include a sequence of measured data values made over a previous time interval. Optionally, modeled data includes a sequence of modeled data values made over a previous time interval. In one embodiment, modeled data includes a sequence of summary statistics associated with the sequence of modeled data values. For example, the modeled data may include variances, confidence limits, etc.

As used herein, aggregation may correspond to a process of data reduction in which multiple data sets are combined to form a single resultant data set. Optionally, the combination method used corresponds to an aggregation type, such as a summation or an average. Optionally, identifying the aggregation type includes receiving input corresponding to determination of the aggregation type. In a specific embodiment, aggregating includes forming a single aggregated previous data set from the filtered previous data. Additionally or alternatively aggregating includes forming a single aggregated modeled data set from the filtered modeled data. Optionally, an aggregate prediction includes predicted data for an upcoming time interval.

Because multiple data sets are combined during an aggregation, some of the statistical information for the data sets may be unavailable. For example, certain statistical information may be carried forward through an aggregation process in a way that makes sense, such as an average, while other statistical information may not be so combinable. A reconciliation process may be useful for allowing generation of summary statistics for a prediction based on summary statistics for individual modeled data sets, individual actual data sets, or aggregated data sets. In one embodiment, reconciling includes determining the prediction statistics for the aggregate prediction using a plurality of summary statistics corresponding to the filtered modeled data set. Optionally, reconciling includes determining the prediction statistics for the aggregate prediction by computing variances between the aggregated modeled data set and the aggregated previous data set. Alternatively or additionally, the prediction statistics include confidence limits for the aggregate prediction. Optionally, the confidence limits for the aggregate prediction are determined using summary statistics for the filtered previous data. In a specific embodiment, the prediction statistics include variances for the aggregate prediction.

In addition to the operations and steps performed by the systems, methods, and computer program products described above, other operations or steps may be included. For example, operations or steps of generating a display of the aggregate prediction may be performed. Optionally, operations or steps of generating a display of the prediction statistics may be performed.

Optionally, notifications may be generated that may be transmitted to and/or displayed by a remote system. For example, a summary report of a filtration, a prediction, and/or prediction statistics may be generated, for example based on the filtration criteria, aggregate predictions, and prediction statistics, and this report may be transmitted to a remote system. Optionally, the remote system may generate a notification of the report in order to alert a user that a filtering, prediction, or reconciliation process is completed. This may advantageously allow a user to remotely initialize a filtration, aggregation, prediction, or reconciliation process and then be alerted, such as via a notification wirelessly received on a mobile device, when the processing is complete and a report may be available. Optionally, a report and/or results of the filtration, aggregation, prediction, and/or reconciliation processes may be transmitted over a network connection to the mobile or remote device.

User preferences may be identified to determine which information to include in a report or which results to be provided to a user. Such preferences may facilitate reducing the total information provided to a user, such as via a mobile device, to allow for more expedient transmission and notification. Additionally, there may be significant user requests for remote processing capacity such that a user may need to have prompt notification of completion of a request in order to queue their next request. Such a notification and report alert system may facilitate this.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The present disclosure is described in conjunction with the appended figures:

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to embodiments of the present technology.

FIG. 9 illustrates a flow chart showing an example process performed by an event stream processing engine, according to some embodiments of the present technology.

FIG. 10 illustrates an ESP system interfacing between a publishing device and multiple event subscribing devices, according to embodiments of the present technology.

FIG. 11A provides an overview of an example of dynamic filtration of data.

FIG. 11B provides an overview of an example of dynamic aggregation and reconciliation of data.

FIG. 12A and FIG. 12B provide examples of data in overlapping and non-overlapping forms.

FIG. 13A and FIG. 13B provide examples of filtered data in overlapping and non-overlapping forms.

FIG. 14A and FIG. 14B provide examples of filtered data in overlapping and non-overlapping forms.

FIG. 15 provides an example of filtered aggregated data, modeled data, predicted data, and prediction statistics.

FIG. 16 provides an overview of an example process for dynamic data filtering, aggregation, and prediction.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

The systems, methods, and products described herein are useful for data analysis. In one aspect, this disclosure provide tools for analyzing large sets of data, such as large sets of digital data. Aspects of the current disclosure provide technical solutions to the technical problem of how to efficiently sort, process, evaluate and make use of large quantities of digital or electronic data. As such, the problem addressed by this disclosure specifically arises in the realm of computers and networks and this disclosure provides solutions necessarily rooted in computer technology. For example, in embodiments, this disclosure is directed to more than just retrieving and storing the data sets and include aspects that transform the data from one form into a new form through filtering, aggregation, prediction, and reconciliation processes.

In one aspect, this disclosure provides tools for making predictions based on large sets of data and for evaluating the accuracy of the predictions. For example, techniques are described for reducing data sets through filtering and aggregation techniques to allow a large quantity of data to be efficiently sorted and summarized, while also providing insights as to how reliable the data is, such as by way of prediction statistics. It will be appreciated that prediction statistics may correspond to predicted summary statistics for predicted data, such as standard errors, confidence limits, etc. Additionally, the disclosed techniques are useful for making predictions about events or values that have yet to occur based on filtered/aggregated data and various models, and to provide a measure of statistical significance to the predictions. The disclosed techniques further allow the data to be processed, aggregated, and filtered dynamically and in real time, to provide tools for analysts to efficiently determine which data should be included and which data should be excluded when making predictions. It will be appreciated that different aspects of the processing, analyzing, and predicting may be performed by different systems, servers, computing environments, or nodes on a network and, further, that storage of data and transport of data may be handled by different systems, servers, computing environments, nodes, or network links of a data transmission network.

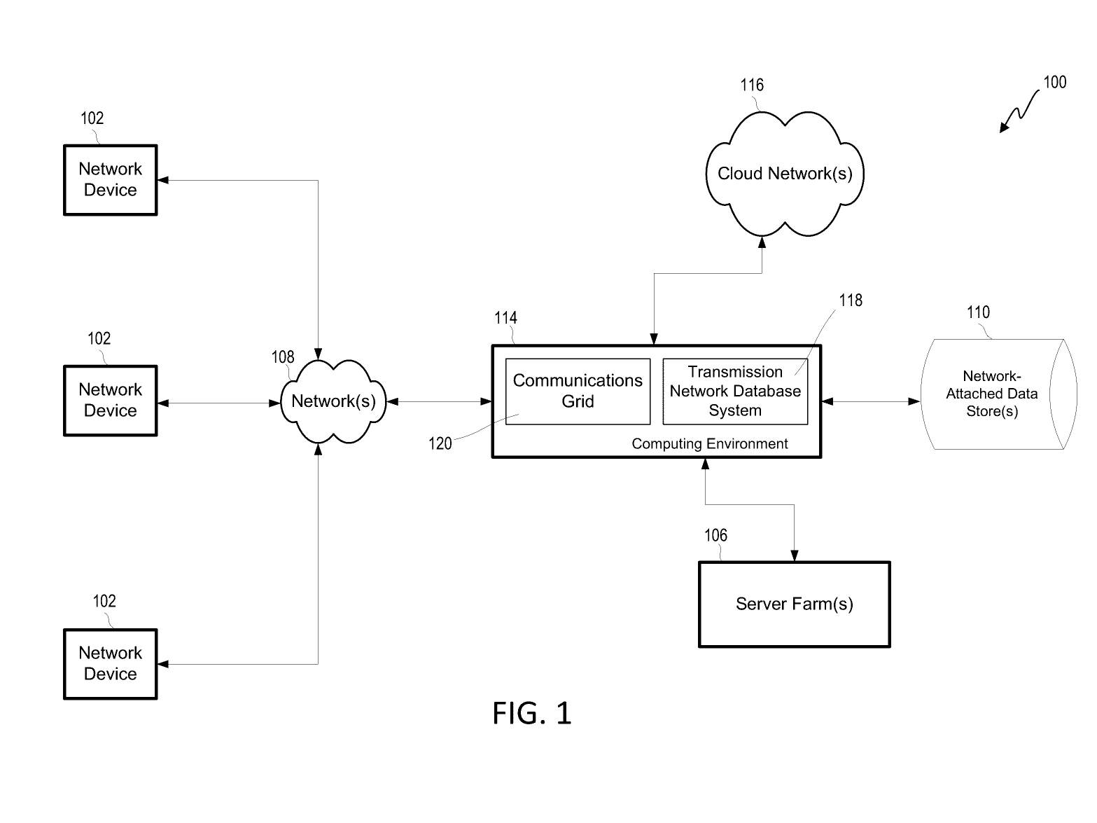

FIG. 1 is a block diagram that provides an illustration of the hardware components of a data transmission network 100, according to embodiments of the present technology. Data transmission network 100 is a specialized system that may be used for processing large amounts of data where a large number of processing cycles are required.

Data transmission network 100 may also include computing environment 114. Computing environment 114 may be a specialized or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

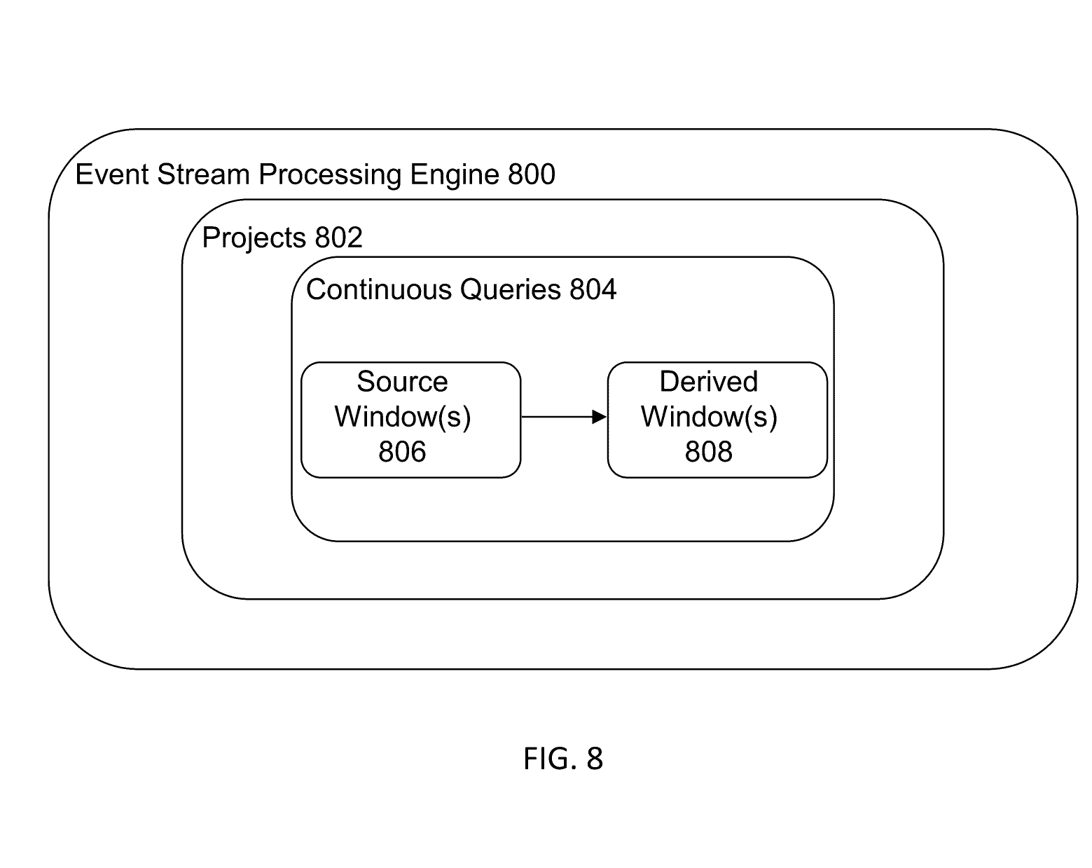

In other embodiments, network devices may provide a large amount of data, either all at once or streaming over an interval of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices, and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory computer readable storage medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying objects being manufactured with parameter data for each object, such as colors and models) or object output databases (e.g., a database containing individual data records identifying details of individual object outputs/sales).

The unstructured data may be presented to the computing environment 114 in different forms such as a flat file or a conglomerate of data records, and may have data points and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time interval units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system as needed. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may comprise one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, as needed, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

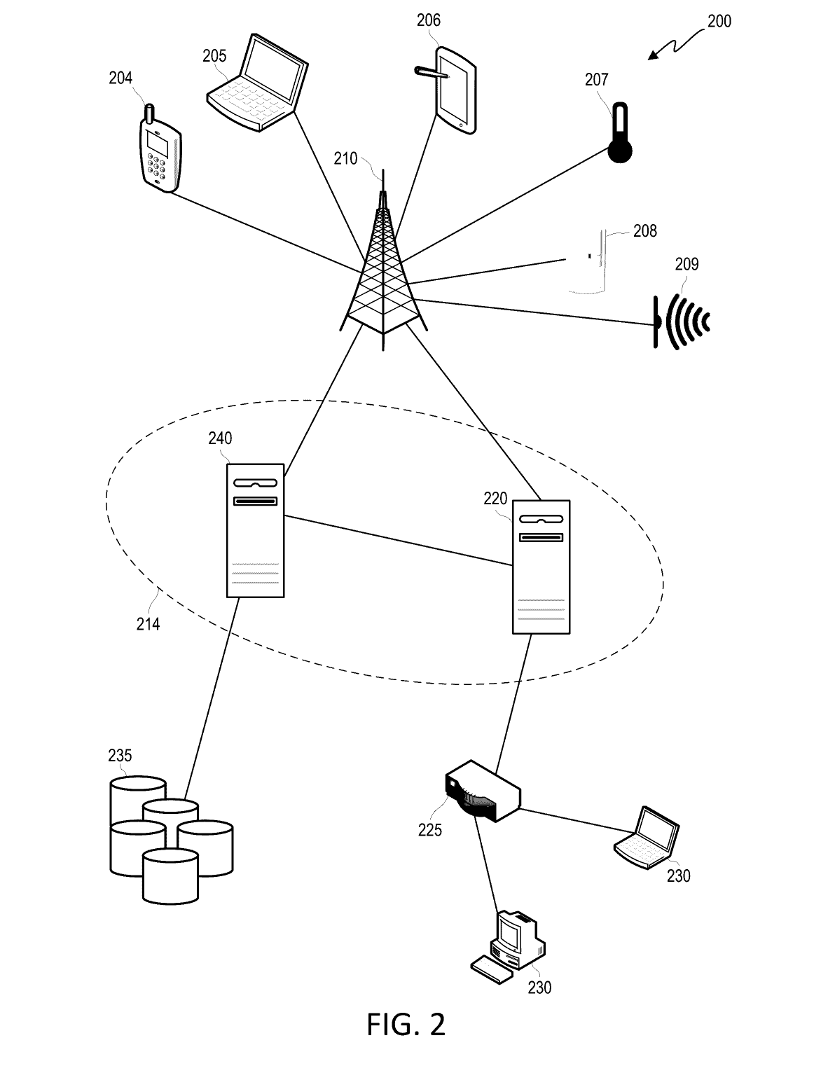

Each communication within data transmission network 100 (e.g., between client devices, between a device and connection system 150, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired and/or wireless networks may be implemented using routers, access points, bridges, gateways, or the like, to connect devices in the computing environment 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and relational analytics can be applied to identify hidden relationships and drive increased effectiveness. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, electrical current, among others. The sensors may be mounted to various components used as part of a variety of different types of systems (e.g., an oil drilling operation). The network devices may detect and record data related to the environment that it monitors, and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, and homes, among others. One or more of such devices may include one or more sensors that detect energy gain or loss, electrical input or output or loss, and a variety of other benefits. These sensors may collect data to inform users of how the energy grid, and individual devices within the grid, may be functioning and how they may be better utilized.

Network device sensors may also process data collected before transmitting the data to the computing environment 114, or before deciding whether to transmit data to the computing environment 114. For example, network devices may determine whether data collected meets certain rules, for example by comparing data or points calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operation, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., object information, client rules, etc.), technical object details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over an interval of time for a client to determine results data based on the client's needs and rules.

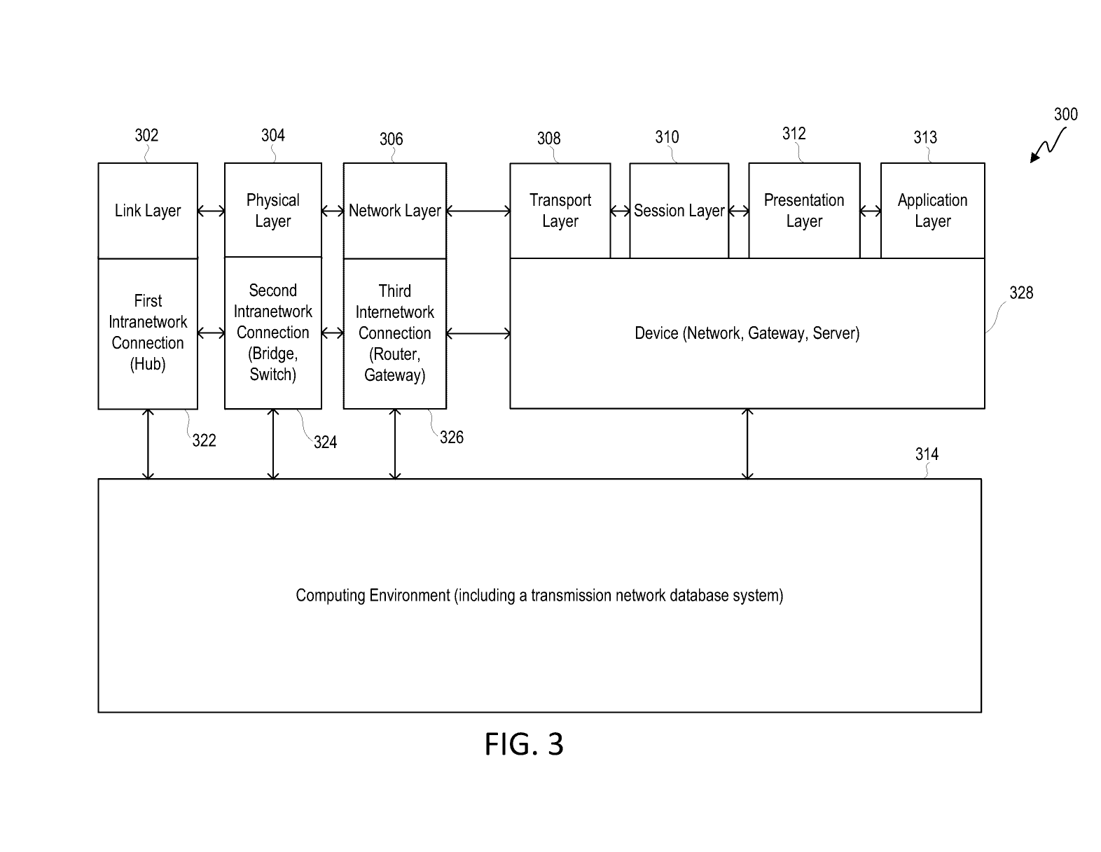

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 302-313. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with an application.

As noted, the model includes a physical layer 302. Physical layer 302 represents physical communication, and can define parameters of that physical communication. For example, such physical communication may come in the form of electrical, optical, or electromagnetic signals. Physical layer 302 also defines protocols that may control communications within a data transmission network.

Link layer 304 defines links and mechanisms used to transmit (i.e., move) data across a network. The link layer handles node-to-node communications, such as within a grid computing environment. Link layer 304 can detect and correct errors (e.g., transmission errors in the physical layer 302). Link layer 304 can also include a media access control (MAC) layer and logical link control (LLC) layer.

Network layer 306 defines the protocol for routing within a network. In other words, the network layer coordinates transferring data across nodes in a same network (e.g., such as a grid computing environment). Network layer 306 can also define the processes used to structure local addressing within the network.

Transport layer 308 can handle the transmission of data and the quality of the transmission and/or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and handle communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt and/or format data based on data types known to be accepted by an application or network layer.

Application layer 313 interacts directly with applications and end users, and handles communications between them. Application layer 313 can identify destinations, local resource states or availability and/or communication content or formatting using the applications.

Intra-network connection components 322 and 324 are shown to operate in lower levels, such as physical layer 302 and link layer 304, respectively. For example, a hub can operate in the physical layer, a switch can operate in the physical layer, and a router can operate in the network layer. Inter-network connection components 326 and 328 are shown to operate on higher levels, such as layers 306-313. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system (DBMS), controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

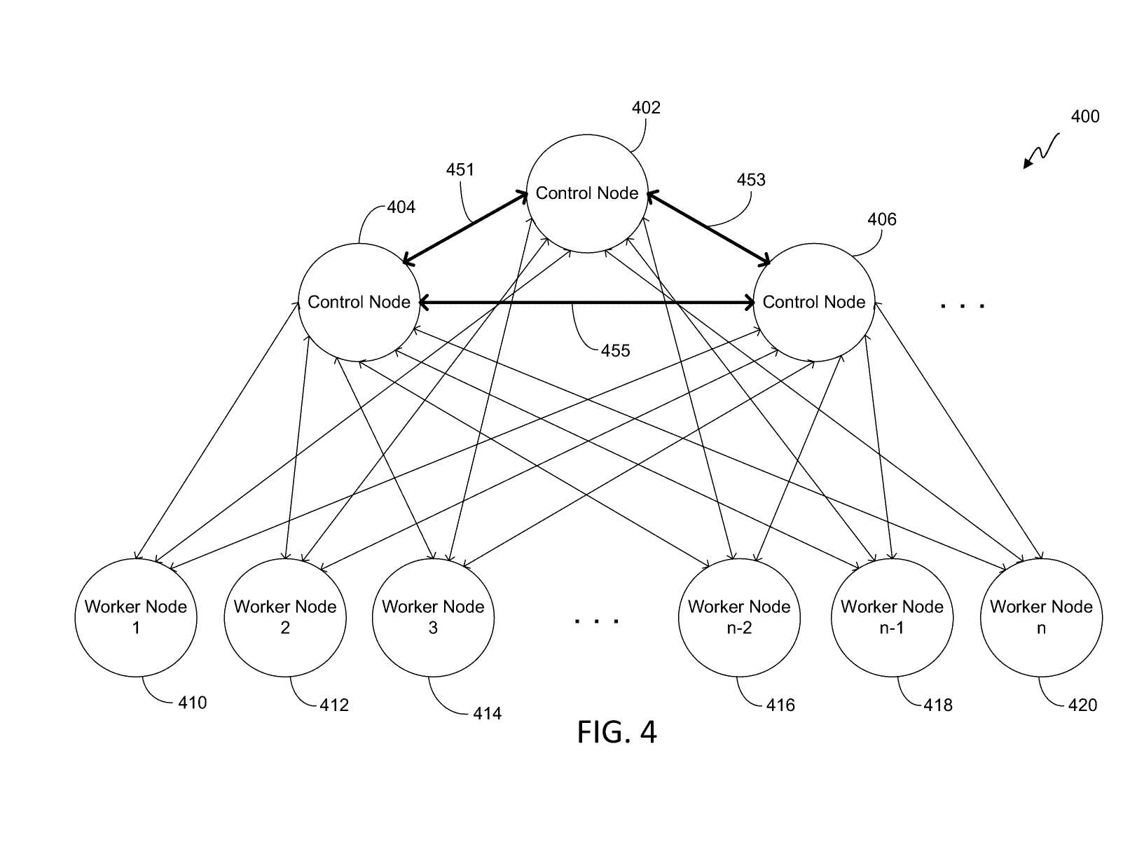

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be receive or stored by a machine other than a control node (e.g., a Hadoop data node).

Control nodes may maintain knowledge of the status of the nodes in the grid (i.e., grid status information), accept work requests from clients, subdivide the work across worker nodes, coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most effectively and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes). The primary control node may be provided with a list of other nodes (e.g., other machines, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined interval of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed.

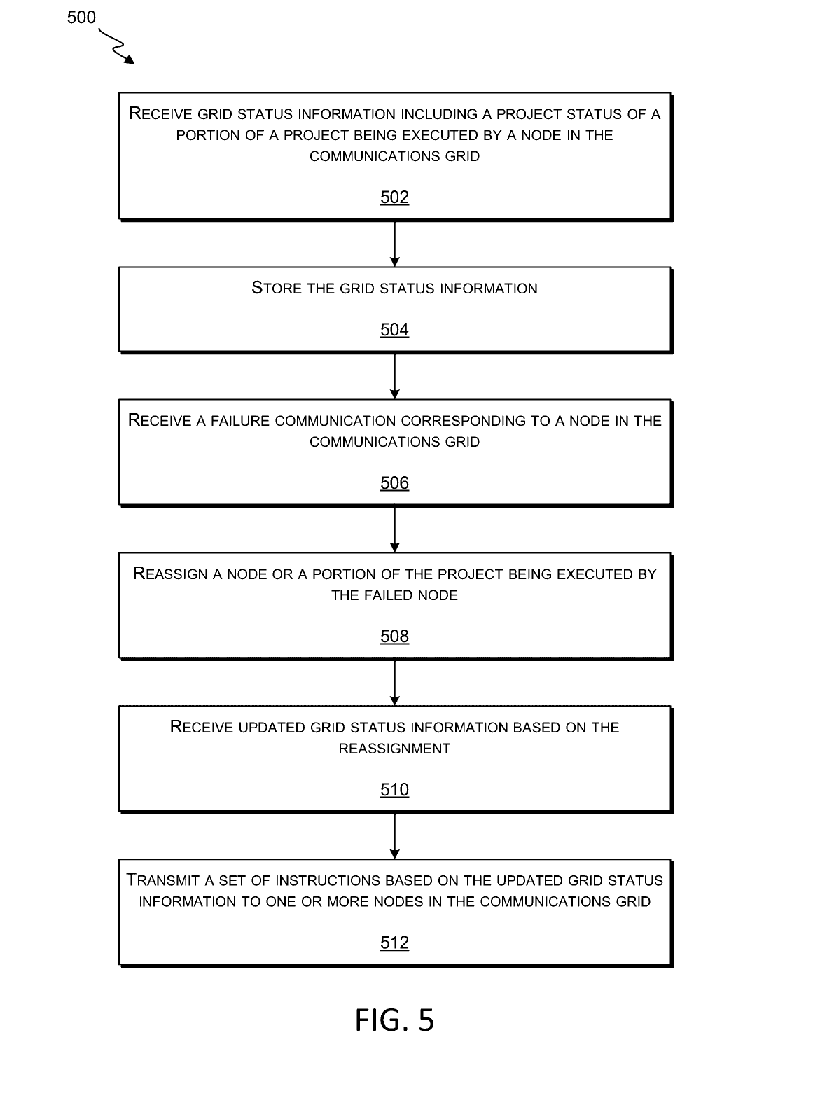

FIG. 5 illustrates a flow chart showing an example process for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

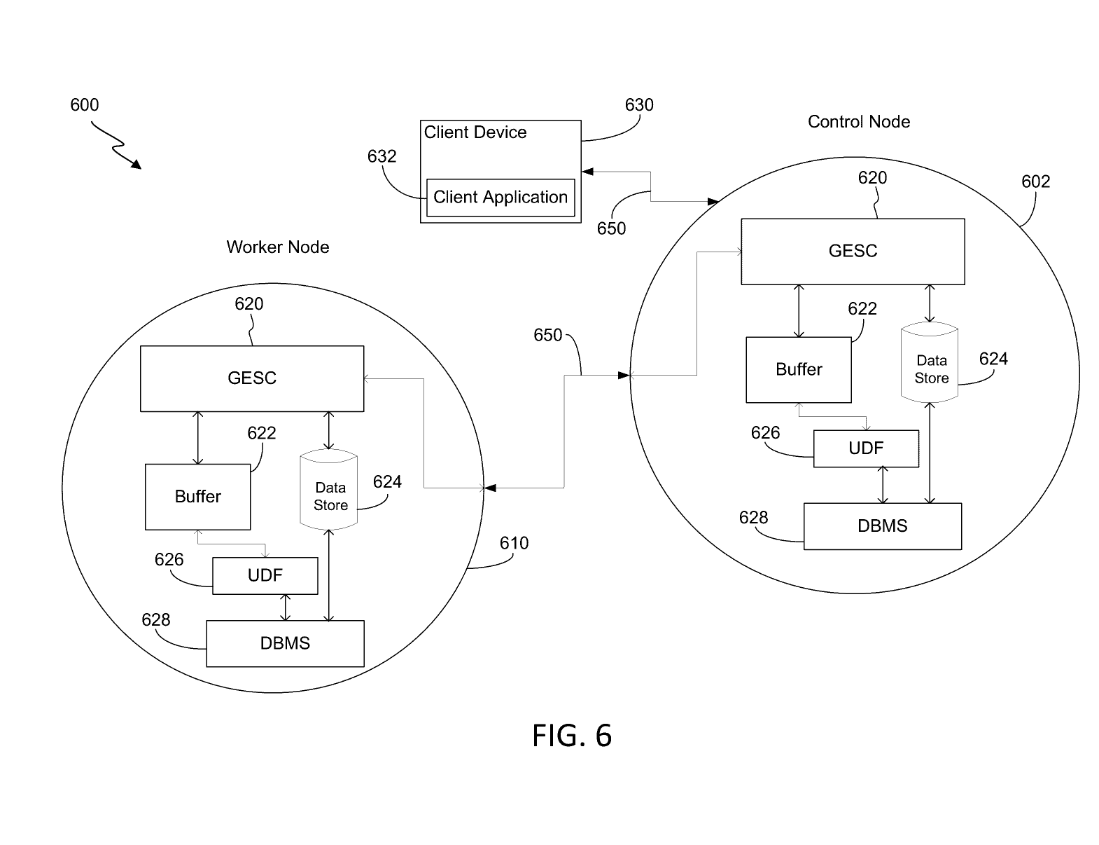

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 comprise multi-core data processors. Each node 602 and 610 includes a grid-enabled software component (GESC) 620 that executes on the data processor associated with that node and interfaces with buffer memory 622 also associated with that node. Each node 602 and 610 includes a DBMS 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DMBS 628 to transfer data to or receive data from the database stored in the data stores 624 that are handled by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) instructions. Each node may be capable of operating as either a control node or a worker node. The GESC at the control node 602 can communicate, over a communication path 652, with a client deice 630. More specifically, control node 602 may communicate with client application 632 hosted by the client device 630 to receive queries and to respond to those queries after processing large amounts of data.

DMBS 628 may control the creation, maintenance, and use of database or data structure (not shown) within a nodes 602 or 610. The database may organize data stored in data stores 624. The DMBS 628 at control node 602 may accept requests for data and transfer the appropriate data for the request. With such a process, collections of data may be distributed across multiple physical locations. In this example, each node 602 and 610 stores a portion of the total data handled in the associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

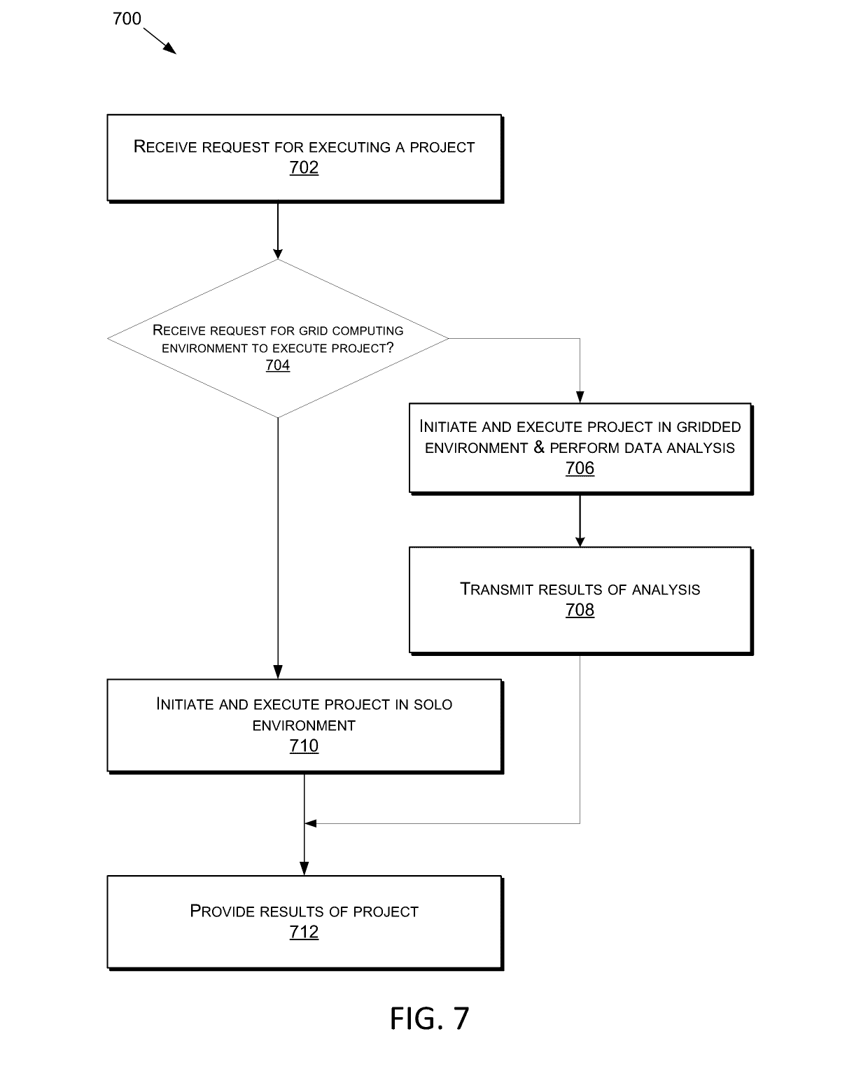

FIG. 7 illustrates a flow chart showing an example method for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project.

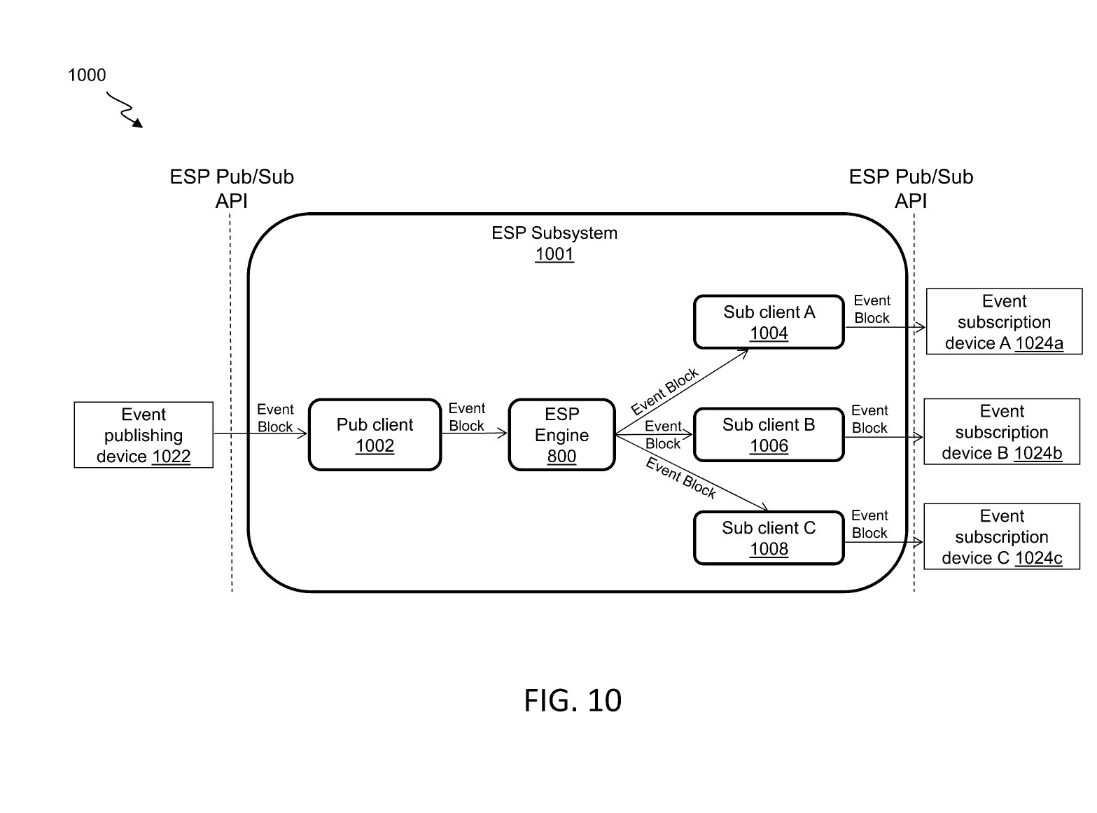

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model handled by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over an interval of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that handles the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other techniques on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field data points and include both metadata and field data associated with an event. The metadata may include an opcode indicating if the event represents an insert, update, delete, or upsert, a set of flags indicating if the event is a normal, partial-update, or a retention generated event from retention policy handling, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

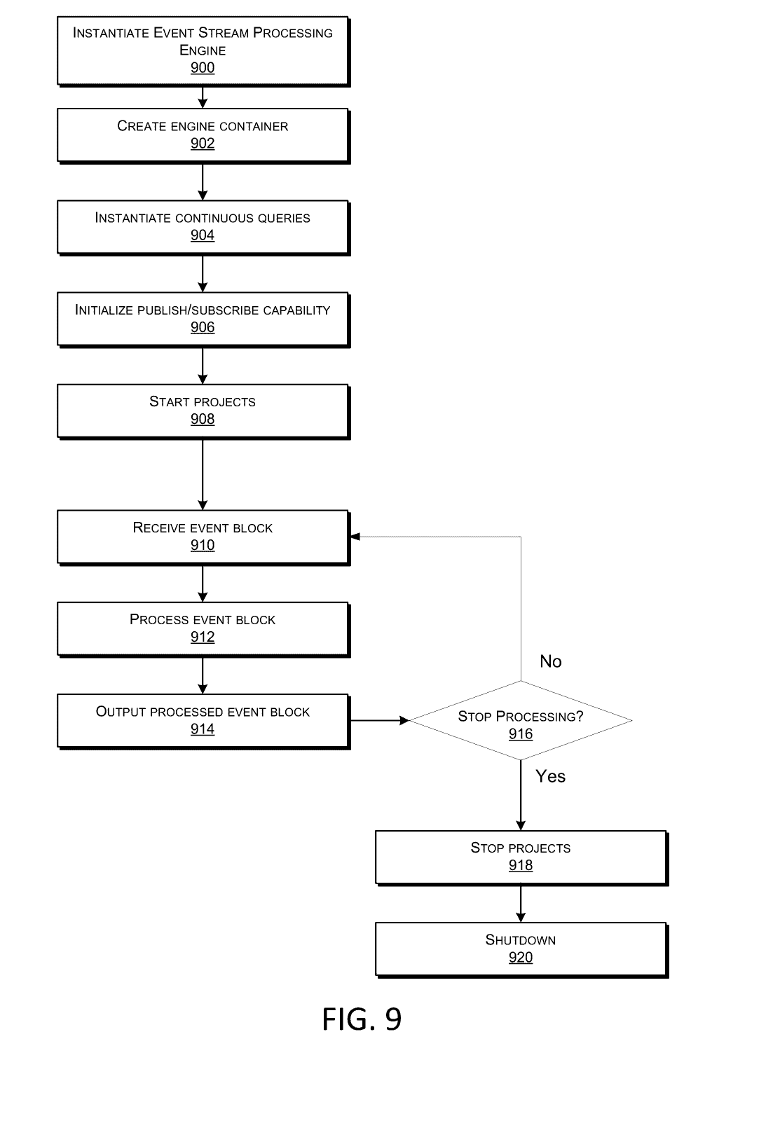

FIG. 9 illustrates a flow chart showing an example process of an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a handler for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and handling (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 1001, event publishing device 1022, an event subscribing device A 1024a, an event subscribing device B 1024b, and an event subscribing device C 1024c. Input event streams are output to ESP device 1001 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 806, and subscribing client C 808 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 804, subscribing client B 806, and subscribing client C 808 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a machine-readable medium operably coupled to the processor. The processor is configured to execute an ESP engine (ESPE). The machine-readable medium has instructions stored thereon that, when executed by the processor, cause the computing device to support the failover. An event block object is received from the ESPE that includes a unique identifier. A first status of the device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory machine-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory machine-readable medium.

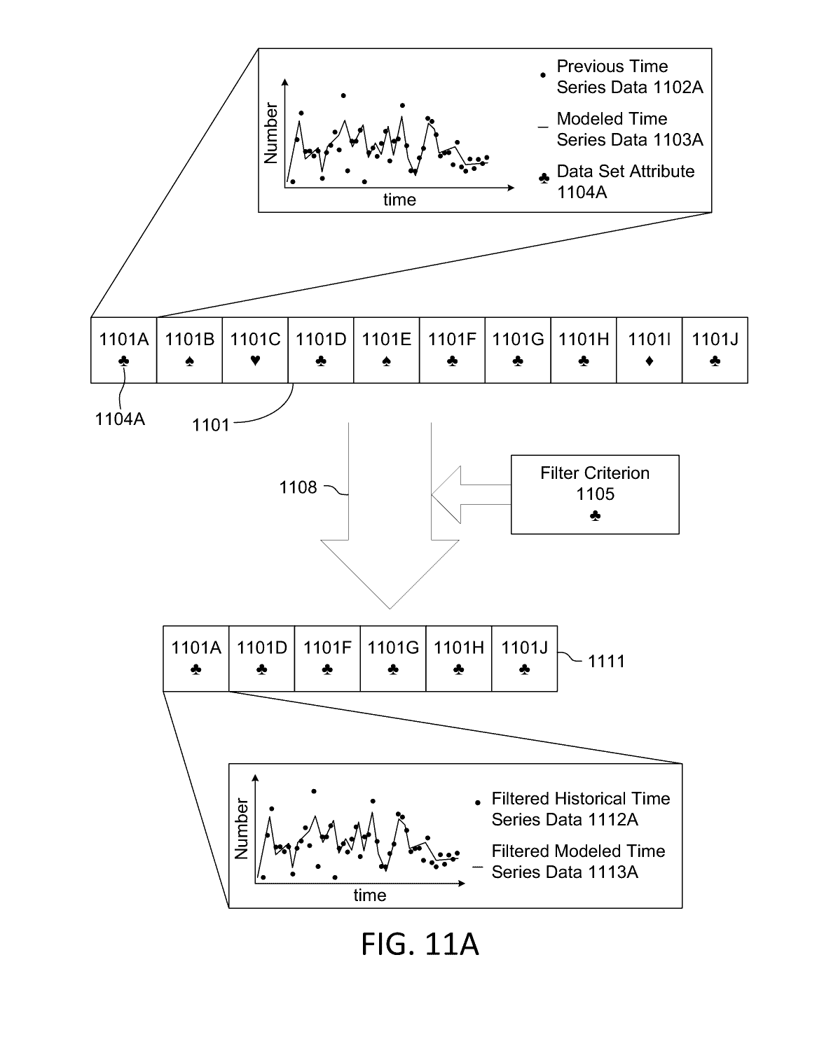

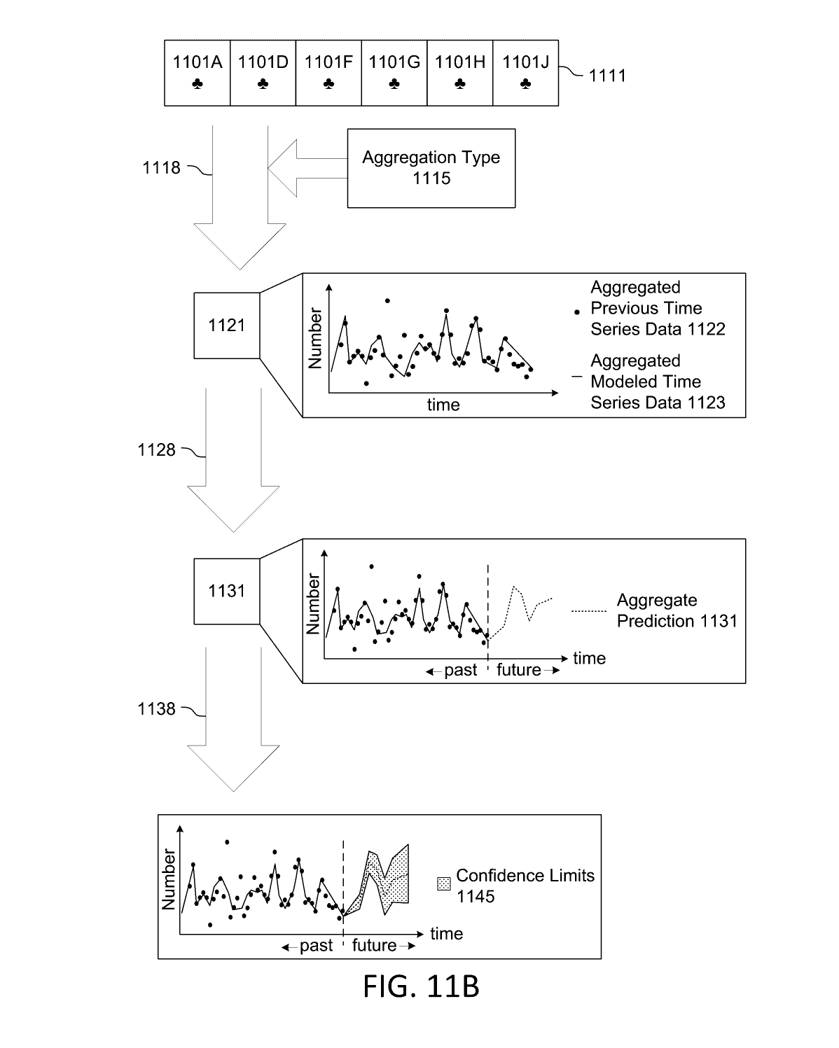

FIG. 11A provides an overview of dynamic filtration of data 1101. Data 1101 includes a plurality of data sets, 1101A, 1101B, 1101C, 1101D, 1101E, 1101F, 1101G, 1101H, 1101I and 1101J. Each of the data sets 1101A-1101J include at least one time series data and at least one data set attribute (also referred to herein as a time series attribute). As illustrated, data sets 1101A-1101J each include previous time series data (also referred to herein as past data, past time series, past time series data, historical data, historical time series, or historical time series data) and modeled time series data (also referred to herein as model data, model time series or model time series data). It will be appreciated that previous time series data may correspond to a first time series and that modeled times series data may correspond to a second time series. It will be appreciated that modeled times series data may correspond to data that is generated, for example, by use of historical time series data with one or more modeling techniques that estimate time series values for the data represented by the previous time series data. For example, modeled time series data may correspond to, for example, a trend line, such as a running average trend line, or may correspond to some other numeric model that is generated using historical time series data as input. It will be further appreciated that modeled time series data is optional and not required for the processes described later, which may instead use only the historical time series data and not any modeled time series data. Previous time series data 1102A and modeled time series data 1103A for data set 1101A are explicitly illustrated in FIG. 11A.

Each time series may correspond to a sequence of data values (e.g., measured or modeled) made over or for a previous time interval. It will be appreciated that the data sets may also include summary statistics that provide information about the individual time series data, such as standard errors, confidence limits, etc. Data sets also may have one or more attributes. It will be appreciated that data set or time series attributes may relate to descriptive characteristics of the data set and/or time series data. These attributes may include or relate to information about an object, product, product line, geographical or regional information, and other attributes which may characterize the data set or time series data. For simplicity of illustration, data set attributes are depicted in FIG. 11A as one of four different suits, akin to the suits of French style playing cards—hearts (♡), diamonds (♦), clubs ( [symbol] ), and spades ( [symbol] ). For example, data set 1101A has a data set attribute 1104A that is illustrated as a club ( [symbol] ).

Filter criterion 1105 is received and a filtering process 1108 is used to reduce the data 1101 to a filtered plurality of data sets 1111 that is a subset of data 1101 and that include data sets having a time series attribute that corresponds to the filter criterion 1105. As illustrated, the filter criterion is a club ( [symbol] ) and the filtered plurality of data 1111 includes all data sets from data 1101 that include a data set attribute that is a club ( [symbol] )—specifically, data sets 1101A, 1101D, 1101F, 1101G, 1101H, and 1101J. After the filtering process, the time series data of each of the data sets in the filtered plurality of data sets 1111 may be referred to as filtered data, such as filtered historical time series data 1112A and filtered modeled time series data 1113A for data set 1101A, and each of the data sets in the filtered plurality of data sets 1111 may include a common data set attribute.

In some aspects, the filter criterion 1105 may be user provided, such as using input provided by a user to a keyboard or other input device. Optionally, displays of the data 1101, data sets 1101A-1101J, filtered plurality of data sets 1111, or individual data sets of the filtered plurality of data sets 1111 may be generated to aid in the filtering process. For example, a first filter criterion may be received and filtering process 1108 may generate a first filtered plurality of data sets that may be displayed, and the user may view the displayed data and determine that a different or additional filter criterion may be more desirable, such that a second filter criterion may be received and filtering process 1108 may generate a second filtered plurality of data sets that may be displayed. In this way, the filtering process may be performed dynamically and/or with user interaction to allow for efficient determination of an appropriately filtered plurality of data sets.

FIG. 11B provides an overview of an example of dynamic aggregation and reconciliation of data. The filtered plurality of data sets 1111 may be used in an aggregation process 1118, where an aggregation type 1115 is identified to use in the generation of an aggregated data set 1121, which may include aggregated previous time series data 1122 and aggregated modeled time series data 1123. Various aggregation types 1115 are contemplated, such as a total, average, or other aggregation statistical technique that allows for data combination and/or summarization, such as where different data sets are given different statistical weights. As simple examples, the “total” aggregation type may refer to a technique where the filtered plurality of data sets are summed, and the “average” aggregation type may refer to a technique where the filtered plurality of data sets are summed and divided by the number of individual data sets. For example, in an embodiment where each data set includes 10 data points and the aggregation type 1115 is “total”, the aggregated data set 1121 may include 10 data points, where each data point corresponds to a summation of the corresponding individual data points from each data set. By this, aggregating may form a single aggregated data set from a plurality of time series. In the example of FIG. 11B, the first point in aggregated previous time series data 1122 may correspond a sum of each of the first points in the previous time series data of each of data sets 1101A, 1101D, 1101F, 1101G, 1101H and 1101J, the second point in point in aggregated previous time series data 1122 may correspond a sum of the second points in the previous time series data of each of data sets 1101A, 1101D, 1101F, 1101G, 1101H and 1101J, and so on. In this way, the data of aggregated data set 1121 may include contributions from each of the data sets in the filtered plurality of data sets 1111. Similarly, in the example of FIG. 11B, the first point in aggregated modeled time series data 1123 may correspond a sum of each of the first points in the modeled time series data of each of data sets 1101A, 1101D, 1101F, 1101G, 1101H and 1101J, the second point in point in aggregated modeled time series data 1123 may correspond a sum of the second points in the modeled time series data of each of data sets 1101A, 1101D, 1101F, 1101G, 1101H and 1101J, and so on. It will be appreciated that aggregated data set 1121 may independently correspond to aggregation of filtered historical time series data to generate aggregated previous time series data 1122 and/or aggregation of filtered modeled time series data to generate aggregated modeled time series data 1123. In one embodiment, both aggregated previous time series data 1122 and aggregated modeled time series data 1123 are determined and each may be independently evaluated for later use in further modeling or prediction processes.

After aggregation process 1118, aggregated data set 1121 may be used in a prediction process 1128 in which an aggregate prediction 1131 is generated, which may correspond to a prediction or forecast based on the aggregated data set 1121 or a portion thereof. It will be appreciated that either or both the aggregated previous time series data 1122 and aggregated modeled time series data 1123 may be used to generate aggregate prediction 1131. It will be appreciated that modeled time series data for aggregated data set 1121 and filtered modeled time series data for filtered plurality of data sets 1111 are different from the aggregate prediction. For example, as illustrated in FIG. 11B, aggregate prediction 1131 may include data corresponding to an upcoming time period for which no data is available in aggregated data set 1121 or filtered plurality of data sets 1111. Additionally or alternatively, modeling of aggregated previous time series data 1122 may be performed to generate a modeled aggregated time series data (not illustrated), which may be used in prediction process 1128 to generate the aggregate prediction 1131.

After prediction process 1128, the aggregate prediction 1131 is used in a reconciliation process 1138 to determine prediction statistics for the aggregate prediction 1131. For example, the aggregate prediction 1131 may be reconciled with the aggregated modeled time series data 1123 or aggregated previous time series data 1122 to determine prediction statistics, such as prediction confidence limits 1145 for the aggregate prediction 1131. The reconciliation process 1138 advantageously allows for determination of predicted statistical summary information about the aggregate prediction 1131, which may not be available due to the aggregation process 1118, since certain summary statistics of the filtered plurality of data sets 1111 may not be accurately aggregated in all cases. It will be appreciated that summary statistics may include a sequence of summary statistics, which may correspond to each of the data points in a time series.

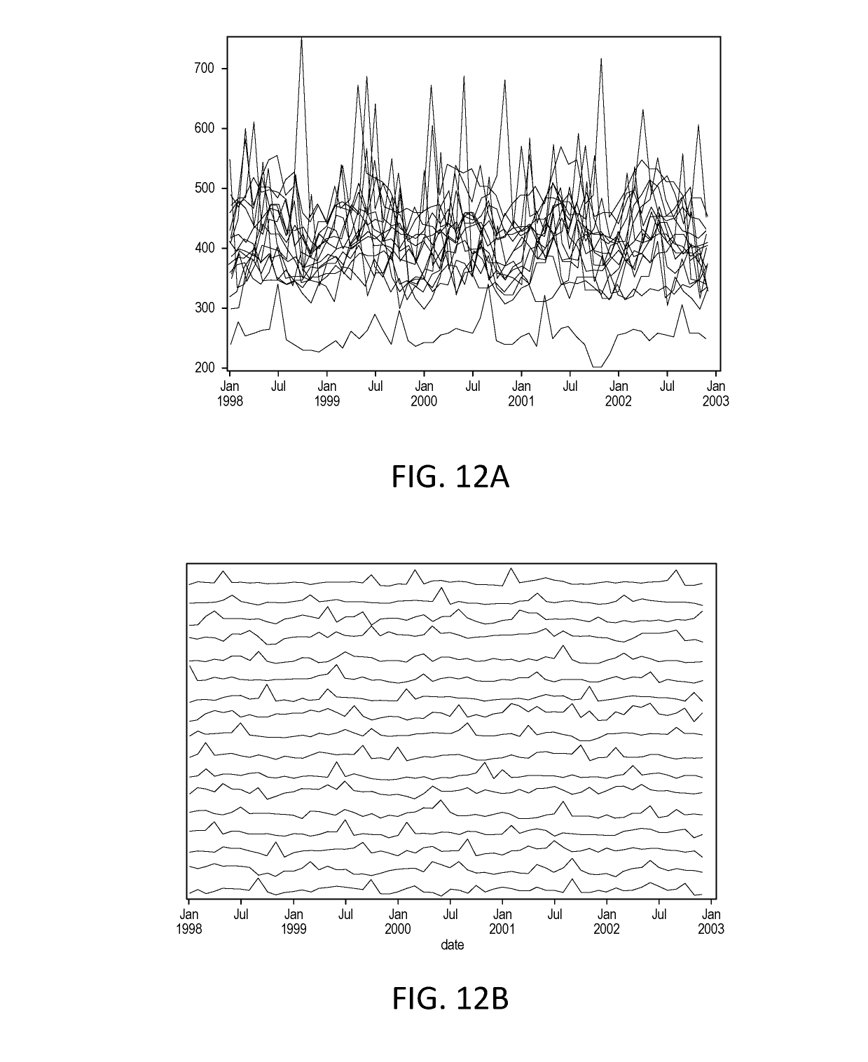

FIG. 12A depicts an example data plot illustrating 17 time series data sets. Each time series data set corresponds to a quantity of objects between the time period of January 1998 and January 2003. FIG. 12B depicts the same data from FIG. 12A in a non-overlapping (stacked) form, such that each time series data set is fully visible.

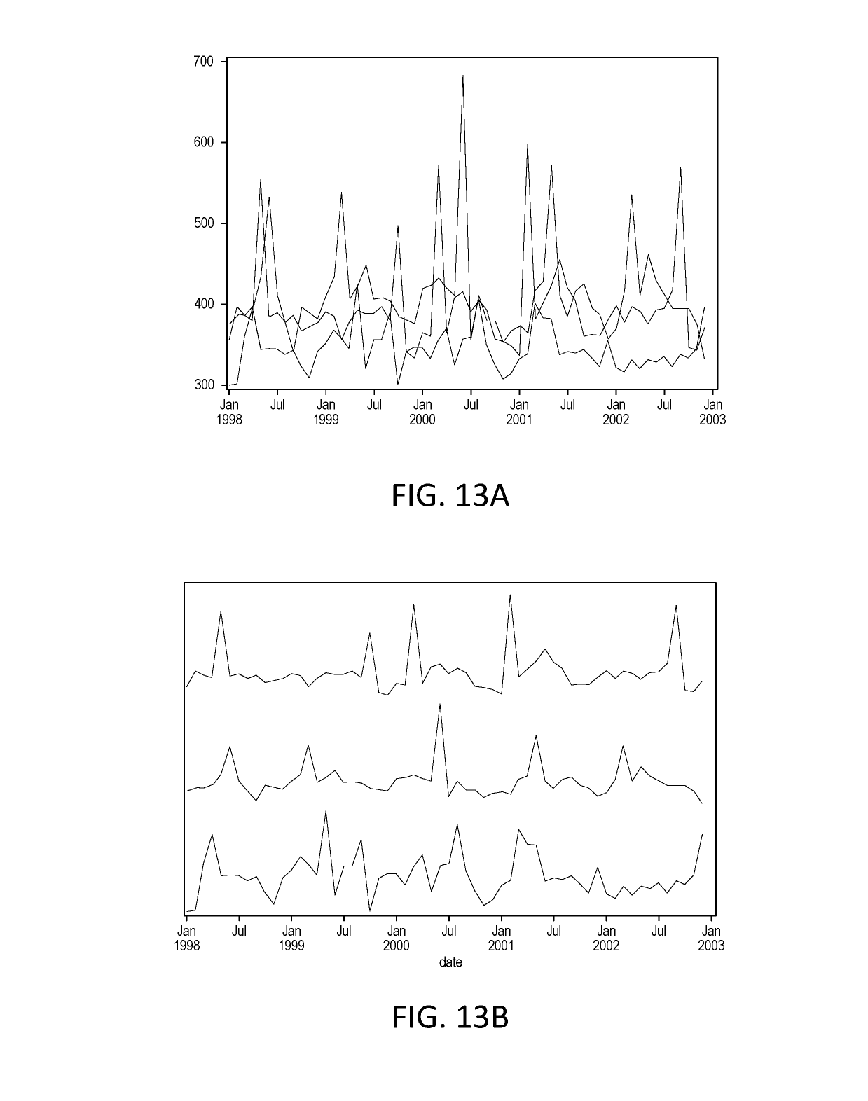

FIG. 13A depicts an example data plot illustrating 3 time series data sets corresponding to a filtered selection of data sets from those depicted in FIG. 12A. Here the time series data sets have been filtered based on a geographical data set attribute, and again correspond to a quantity of objects between the time period of January 1998 and January 2003. FIG. 13B depicts the same data from FIG. 13A in a non-overlapping (stacked) form, such that each time series data set is fully visible.

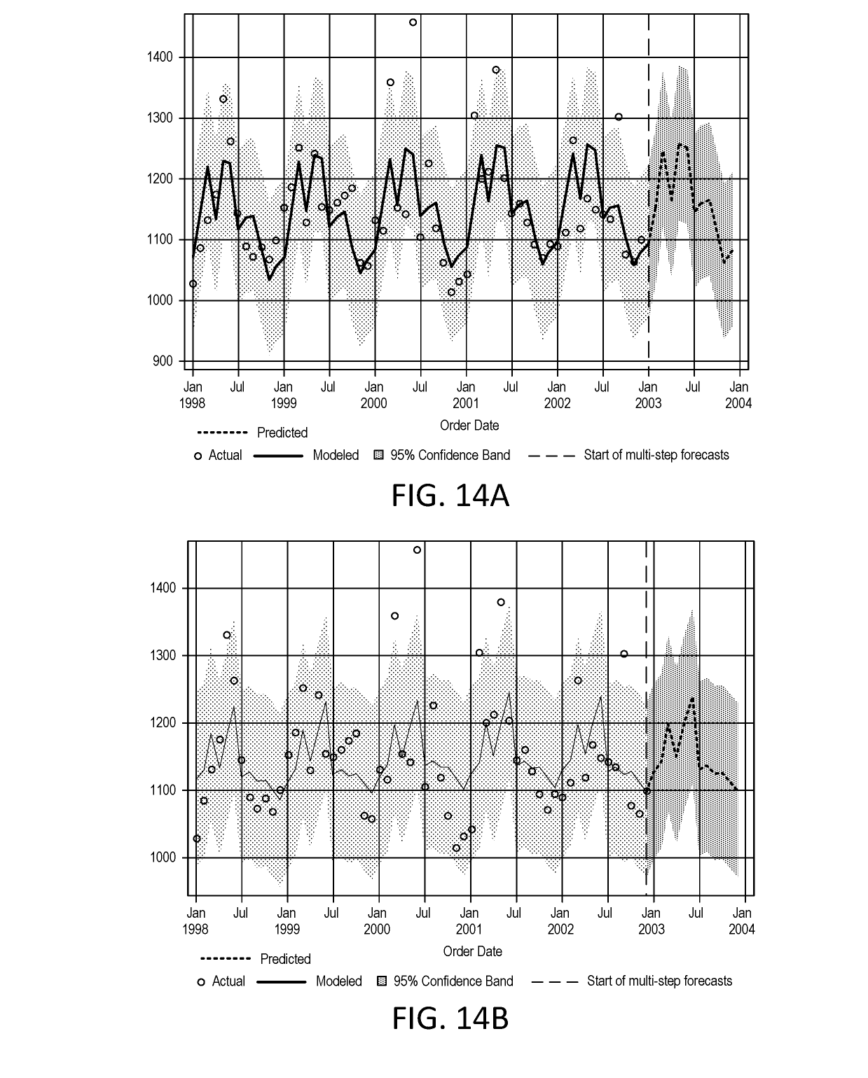

FIG. 14A and FIG. 14B depict example data plots illustrating aggregated data (labeled in FIG. 14A and FIG. 14B as “Actual” and having open circles), aggregate modeled data (labeled as “Modeled” and having a solid line), predicted data (labeled as “Predicted” and having a dashed line), and prediction statistic information (labeled as “95% Confidence Band” and having shading), without reconciliation (FIG. 14A) and with reconciliation (FIG. 14B). It will be appreciated that the aggregate prediction and prediction statistic information extends beyond the range of the original and aggregated data, and shows a prediction for the period between January 2003 and January 2004.

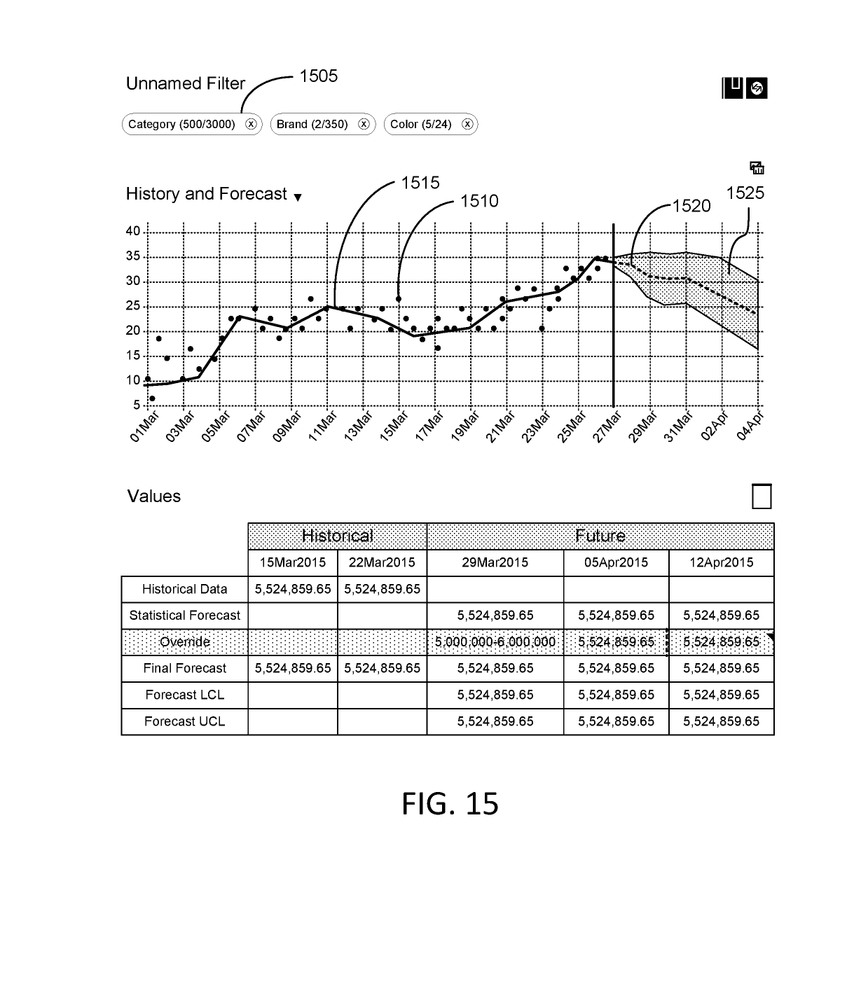

FIG. 15 provides a display showing predicted data, prediction statistics, past data, and modeled data. The display represents an interactive user interface in which a user may identify and/or explore one or more filter criterion 1505 for reducing a size of a data set. As illustrated, the filter criterion 1505 illustrated correspond to filtration based on a category, a brand, and a color. The plot in FIG. 15 illustrates past data 1510 (circular data points), which may correspond to aggregated past data, for example. Also illustrated in the plot in FIG. 15 is modeled data 1515 (solid line), which may correspond to aggregated model data, for example, or a model of the aggregated past data. The past and modeled data correspond to time series data between March 1 and March 27. No past or modeled data is illustrated for the period from March 27 onward. Between March 27 and April 4, predicted data 1520 (dashed line) is depicted. This may correspond to a forecast based on the past data or modeled data shown in FIG. 15. Prediction statistics 1525 for the predicted data 1525 are also illustrated in FIG. 15, and correspond to a confidence band surrounding the predicted data 1525. The Table in FIG. 15 illustrates values for two dates, including past (historical) data and model (final forecast) data. The table also illustrates predicted data for three future dates, an override value, which may be user input or specified and allows a user to adjust the predicted data, and lower and upper confidence limits, which may correspond to prediction statistics generated, for example, through a reconciliation process.

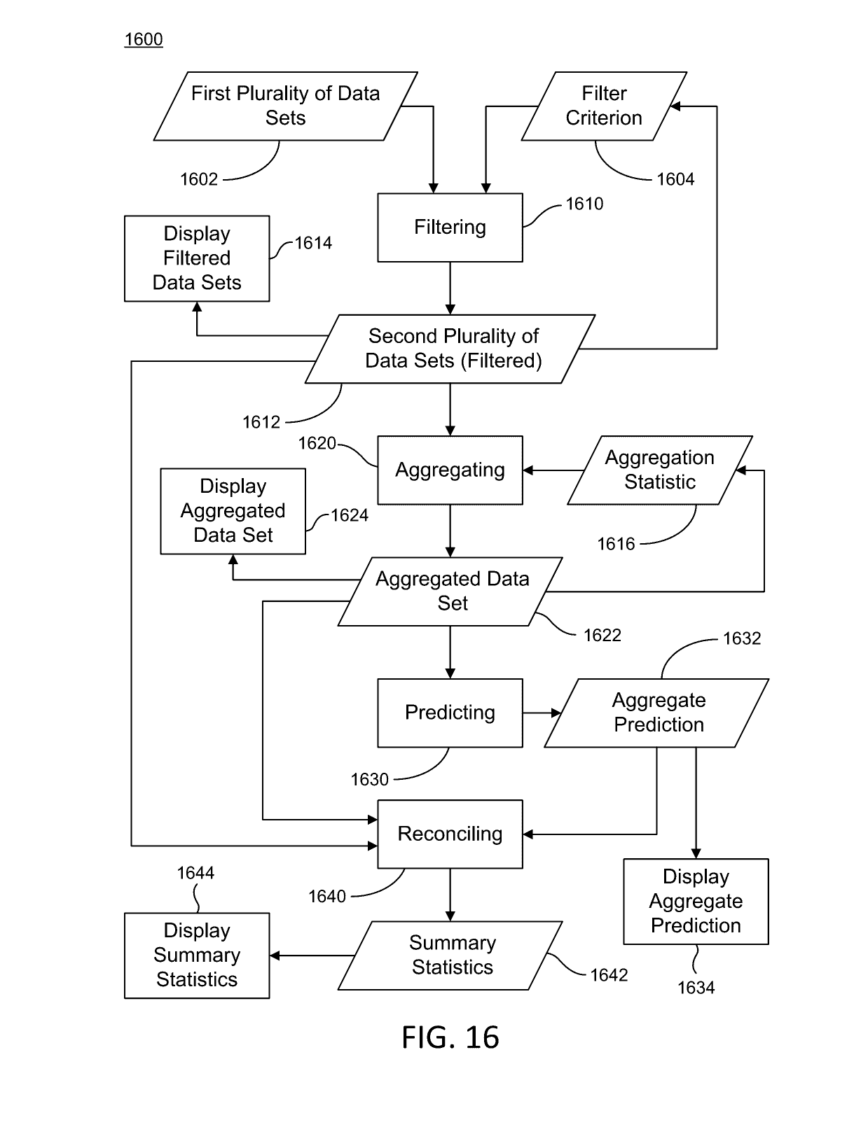

FIG. 16 provides an overview of an example process 1600 for dynamic data filtering, aggregation, and prediction. Initially a first plurality of data sets 1602 is provided. First plurality of data sets may include actual data and/or model data. In practical terms, first plurality of data sets 1602 may correspond to a large quantity of data that may not be practical to sort, visualize, or otherwise use for making predictions. Accordingly, filtering process 1610 may be used to reduce the size or number of the data set that may be visualized or used for making predictions, such as by using one or more filter criterion 1604. Filter criterion 1604 may be user selected or user input and, in embodiments, may be determined by a selection of options or text input by a user. The filtering process 1610 generates a second plurality of data sets 1612, which corresponds to the filtered data sets. Optionally, the second plurality of data sets may be displayed, at block 1614. Displaying the second plurality of data sets 1612 may be useful to allow a user to quickly or efficiently determine whether the filtering process is appropriate and/or whether additional and or different filtering is needed, such as based on a different filter criterion. As such, the filtering process 1610 may be repeated to use additional or different filter criterion 1604.

Once the filtering process 1610 is completed, the second plurality of data sets 1612 may be used in aggregating process 1620, such as to aggregate the second plurality of data sets according to an aggregation statistic 1616. Aggregation statistic 1616 may be user selected or user input and, in embodiments, may be determined by a selection of options or text input by a user. The aggregating process 1620 generates an aggregated data set 1622. Optionally, the aggregated data set 1622 may be displayed, at block 1624. Displaying the aggregated data set 1622 may be useful to allow a user to quickly or efficiently determine whether the aggregating process is appropriate, whether a different aggregation statistic may be more suitable and/or whether additional or different filtering is needed, such as based on a different filter criterion. As such, the aggregating process 1620 may be repeated to use a different aggregation statistic 1616. Additionally or alternatively, the filtering process 1610 may be returned to in order to use additional or different filter criterion 1604.

The aggregated data set 1622 may be used for multiple different processes. For example, the aggregated data set 1622 may be used in a predicting process 1630 that generates an aggregate prediction 1632. Optionally, the aggregate prediction 1632 may be displayed, at block 1634. The aggregate prediction 1632, the aggregated data set 1622, and the second plurality of data sets 1612 may be used in a reconciling process 1640 to determine prediction statistics 1642 for the aggregate prediction 1632. Optionally, the prediction statistics 1642 may be displayed, at block 1644.

Aspects of this disclosure may be further understood by the following non-limiting example.

### EXAMPLE 1

### Dynamic Aggregation Technique

A variety of techniques may be used for generating statistical predictions for a particular data set, automatically generating and selecting data set models that can be used to make predictions, and automatically generating statistical predictions for numerous data sets that are arranged in a particular hierarchy. In addition to these techniques, it is desirable to dynamically view aggregates of the predictions.

Aggregating predictions or modeled data may be difficult because they may not be simple numbers. For example, a prediction for a time period may correspond to a distribution, which includes prediction standard errors and confidence limits. In order to accurately aggregate predictions or modeled data, techniques for preserving the basic distributional properties must be utilized.

This example describes techniques for dynamically aggregating numerous data sets or data set predictions and preserves the basic distributional properties. The technique may utilize a variety of steps including, but not limited to generating data set predictions, subsetting the data set predictions, aggregating the data sets and the data set predictions, making an aggregate prediction based on the aggregated data set and/or the aggregated data set predictions and reconciling the aggregate prediction.

This example explores the use of time series analysis techniques along with prediction reconciliation techniques to provide dynamic predictions of aggregated data sets.

A variety of techniques may be employed to generate the data set predictions for each data set. These statistical predictions may be referred to herein as disaggregates, as they represent independent predictions for individual data sets. The following time indices are used in time series analysis and prediction: a (discrete) time index is represented by t=1, . . . , T, where T represents the length of the data set; the index of future time periods, which may be predicted or modeled, is represented by l=1, . . . , L, where L represents the prediction horizon (also called the lead). The following series indices may further be used: a series index is represented by i=1, . . . , N, where N represents the number of individual data sets; a subset of the data sets is represented by I⊂{1, . . . , N_{I}}, where N_{I} represents the number of series in the subset.

A time series value for series index i at time index t is represented by y_{i,t}. The dependent time series (past actual data) that is to be predicted or modeled is represented by Y_{i,T}={y_{i,t}}ₜ₌₁^{T}. The past actual data may also contain independent series, such as inputs and calendar events that help model and predict the dependent series. The past actual data and modeled data are represented by \vec{X}_{i,T}={\vec{x}_{i,t}}ₜ₌ₗ^{T+L}.

The disaggregates may be subsetted, such as by using manual selection, filtering based on one or more criteria of the various attributes of the data sets, or some other techniques. Filtration optionally permits analysis of related data sets since the filtered data sets may share a common attribute.

After the subset is created, the aggregate prediction may be determined based on the subset. To aggregate the data sets, an aggregation statistic is needed, such as total, average or some other statistic. Aggregating the actual past data and the modeled data of the subset may be straightforward for particular embodiments.

When numerous data sets are available, such as Y_{i,T}={y_{i,t}}ₜ₌₁^{T}, for i=1, . . . , N, the data sets may be aggregated using an aggregation statistic. For a “total” aggregation statistic, the aggregation is performed according to:

$${y}_{* , t} = {\sum }_{i = 1}^{N} {y}_{i , t}$$

For an “average” aggregation statistic, the aggregation is performed according to:

$${y}_{* , t} = \frac{1}{N} {\sum }_{i = 1}^{N} {y}_{i , t}$$

The aggregation may occur over all the series indices, i=1, . . . , N or over a subset of the series indices, I⊂{1, . . . , N_{I}}, if a subset of data sets has been assembled. Note that, in many instances, the prediction standard errors (Std) or confidence limits (Lower and Upper) may not be aggregated in this same way and still retain meaningful information.

At this point, statistical predictions may be needed for the disaggregate data set, Y_{i,T}={y_{i,t}}ₜ₌₁^{T}, and statistical predictions may be needed for the aggregated data set, Y*_{,T}={y*_{,t}}ₜ₌₁^{T}. A variety of techniques may be used to generate these predictions. For example, techniques for generating statistical predictions are described by the following papers, which are hereby incorporated by reference:
Leonard, M. J. 2002. “Large-Scale Automatic Forecasting: Millions of Forecasts.” International Symposium of Forecasting. Dublin.
Leonard, M. J. 2004. “Large-Scale Automatic Forecasting with Calendar Events and Inputs.” International Symposium of Forecasting. Sydney.
Leonard, M. J. and Elsheimer, B. M. 2015. “Count Series Forecasting.” SAS Global Forum 2015. Dallas.
   The disaggregate predictions are represented by Ŷ_{i,T+L}={ŷ_{i,t}}ₜ₌₁^{T+L}, where L is the prediction horizon. Similarly, the aggregate prediction is represented by Ŷ*_{,T+L}={ŷ*_{,t}}ₜ₌₁^{T+L}

Aggregating the predicted standard errors, lower confidence limit, and upper confidence limit for each disaggregate data set may require information (reconciliation) from both the disaggregate predictions and the predictions that are directly generated from the aggregated data, such as the aggregated actual data.

Reconciliation of the aggregate predictions and the numerous individual subset predictions (subsets of the disaggregates) by using a hierarchical prediction reconciliation technique (bottom-up). This reconciliation may involve two levels: a single aggregate and numerous disaggregates. Reconciliation allows for at least partial preservation of the distributional properties.

At this point, the predictions for the numerous disaggregate data sets, Ŷ_{i,T+L}={ŷ_{i,t}}ₜ₌₁^{T+L}, and the aggregate prediction, Ŷ*_{,T+L}={ŷ*_{,t}}ₜ₌₁^{T+L}, are available. However, the aggregate of the predictions for the numerous disaggregate data sets is not necessarily the same as the single aggregate prediction:

$${\hat{y}}_{* , t} \neq {\sum }_{i = 1}^{N} {\hat{y}}_{i , t}$$

$$and$$

$${\hat{y}}_{* , t} \neq \frac{1}{N} {\sum }_{i = 1}^{N} {\hat{y}}_{i , t} .$$

In order to reconcile these differences, reconciliation techniques may be utilized. Consider a simple example, a simple two-series aggregation that uses “total” as the aggregation statistic: ŷ*_{,t}=y_{1,t}+y_{2,t}. Top-down (proportional) reconciliation results in the reconciled predictions in the following equations:

$${\hat{y}}_{* , t}^{R} = {\hat{y}}_{* , t}$$

$${\hat{y}}_{1 , t}^{R} = {\hat{y}}_{1 , t} ( \frac{{\hat{y}}_{* , t}}{{\hat{y}}_{1 , t} + {\hat{y}}_{2 , t}} )$$

$${\hat{y}}_{2 , t}^{R} = {\hat{y}}_{2 , t} ( \frac{{\hat{y}}_{* , t}}{{\hat{y}}_{1 , t} + {\hat{y}}_{2 , t}} )$$

Bottom-up (proportional) reconciliation results in the reconciled predictions in the following equations:

ŷ*_{,t}^{R}=ŷ_{1,t}+ŷ_{2,t} ŷ_{1,t}^{R}=ŷ_{1,t} ŷ_{2,t}^{R}=ŷ_{2,t}

Other forms of hierarchical prediction reconciliation are useful. For example, the following paper, hereby incorporated by reference, describes more information about hierarchial reconciliation:
Trovero, M. A., Joshi, M. V., and Leonard, M. J. 2007. “Efficient Reconciliation of a Hierarchy of Forecasts in Presence of Constraints.” SAS Global Forum 2007. Orlando.

If the disaggregate predictions are considered more reliable, bottom-up reconciliation may be preferred. Bottom-up reconciliation may be considered more reliable when hierarchical time series techniques are used to generate the predictions for the disaggregate data sets. If the aggregate predictions are more reliable, then there may be no need to use reconciliation at all. The numerous disaggregate data sets may be aggregated and a prediction based on the resulting data set may be generated.

In some embodiments, bottom-up reconciliation may be easier than top-down reconciliation, as top-down reconciliation may need to be treated carefully and may be more computationally expensive. This example will further consider bottom-up reconciliation.

From the bottom-up equation, it appears that the predictions need to be aggregated: ŷ*_{,t}^{R}=ŷ_{1,t}+ŷ_{2,t}, however, this equation represents the sum of two random variables and not the sum of two numbers. For example, variances may not always be able to be summed and confidence limits may never be able to be summed.

The means of the predictions are the expected values and may be aggregated:

E[ŷ*_{,t}^{R}]=E[ŷ_{1,t}]+E[ŷ_{2,t}].

The reconciled prediction variances may be calculated using the following techniques: The reconciled prediction variances are the same as the aggregate data set prediction variances:

Var[ŷ*_{,t}^{R}]=Var[ŷ*_{,t}]

The reconciled prediction variances are the proportional to the aggregate data set prediction variances:

$$Var [ {\hat{y}}_{* , t}^{R} ] = {[ \frac{{\hat{y}}_{* , t}^{R}}{{\hat{y}}_{* , t}} ]}^{2} Var [ {\hat{y}}_{* , t} ]$$

The reconciled prediction variances are the sum of the numerous disaggregate data set prediction variances:

Var[ŷ*_{,t}^{R}]=Var[ŷ_{1,t}]+Var[ŷ_{2,t}]

The prediction standard errors are equal to the square root of the prediction variances, regardless of the method used to calculate them:

Std[ŷ*_{,t}^{R}]=\sqrt{[ŷ*_{,t}^{R}]}

The reconciled aggregate data set confidence limits may be calculated in one of the following ways:

Shift the confidence limits by using the difference between the reconciled aggregate data set predictions and the aggregate data set predictions:

Lower[ŷ*_{,t}^{R}]=Lower[ŷ*_{,t}]+(ŷ*_{,t}^{R}−ŷ*_{,t})

Upper[ŷ*_{,t}^{R}]=Upper[ŷ*_{,t}]+(ŷ*_{,t}^{R}−ŷ*_{,t})

Compute the confidence limits by using the reconciled aggregate data set prediction standard errors (assuming a Gaussian distribution with a confidence limit size of α):

Lower[ŷ*_{,t}^{R}]=ŷ*_{,t}^{R}+Z_{(α/2)}Std[ŷ*_{,t}^{R}]

Upper[ŷ*_{,t}^{R}]=ŷ*_{,t}^{R}+Z_{(1-α/2)}Std[ŷ*_{,t}^{R}]

Thus, one technique to obtain an aggregate prediction is to simply aggregate the disaggregate predictions, copy the prediction standard errors (Std), and shift the confidence limits (Lower and Upper).

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

This written description uses examples for disclosure, including the best mode, and also to enable a person skilled in the art to make and use the disclosure. The patentable scope may include other examples that occur to those skilled in the art.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other machine-readable media for use by a computer program.

The systems and methods may be provided on many different types of machine-readable media including computer storage mechanisms (e.g., CD-ROM, diskette, RAM, flash memory, computer's hard drive, etc.) that contain instructions for use in execution by a processor to perform the methods' steps and implement the systems described herein.

What is claimed is:

1. A system comprising:
one or more processors;
a non-transitory computer readable storage medium positioned in data communication with the one or more processors and including instructions that, when executed by the one or more processors, cause the one or more processors to perform operations including:
identifying a plurality of data sets, wherein each data set includes previous data, modeled data, and one or more data set attributes;
receiving a filter criterion for filtering the plurality of data sets based on the data set attributes;
filtering the plurality of data sets using the filter criterion to identify a filtered plurality of data sets that is a subset of the plurality of data sets, wherein each filtered data set has one or more data set attributes that are associated with the filter criterion, and wherein a filtered data set includes filtered previous data and filtered modeled data;
identifying an aggregation type, wherein the aggregation type identifies how the filtered plurality of data sets are to be aggregated;
generating an aggregated data set, wherein generating includes aggregating the filtered plurality of data sets using the aggregation type, wherein the aggregated data set includes an aggregated previous data set and an aggregated modeled data set, wherein the aggregated previous data set is generated using the filtered previous data, and wherein the aggregated modeled data set is generated using the filtered modeled data;
generating an aggregate prediction using the aggregated data set; and
reconciling the aggregate prediction and the aggregated modeled data set to determine prediction statistics for the aggregate prediction.

2. The system of claim 1, wherein previous data includes a sequence of measured data values made over a previous time interval.

3. The system of claim 1, wherein modeled data includes a sequence of modeled data values made over a previous time interval.

4. The system of claim 3, wherein modeled data includes a sequence of summary statistics associated with the sequence of modeled data values.

5. The system of claim 1, wherein identifying the aggregation type includes receiving input corresponding to determination of the aggregation type.

6. The system of claim 1, wherein aggregating includes forming a single aggregated previous data set from the filtered previous data, or wherein aggregating includes forming a single aggregated modeled data set from the filtered modeled data.

7. The system of claim 1, wherein the aggregate prediction includes predicted data for an upcoming time interval.

8. A computer-program product tangibly embodied in a non-transitory machine-readable storage medium, including instructions configured to cause a computing device to perform operations including:
identifying, using a hardware processor of the computing device, a plurality of data sets, wherein the plurality of data sets includes previous data, modeled data, and one or more data set attributes;
receiving a filter criterion for filtering the plurality of data sets based on the data set attributes;
filtering the plurality of data sets using the filter criterion to identify a filtered plurality of data sets that is a subset of the plurality of data sets, wherein each filtered data set has one or more data set attributes that are associated with the filter criterion, and wherein a filtered data set includes filtered previous data and filtered modeled data;
identifying an aggregation type, wherein the aggregation type identifies how the filtered plurality of data sets are to be aggregated;
generating an aggregated data set, wherein generating includes aggregating the filtered plurality of data sets using the aggregation type, wherein the aggregated data set includes an aggregated previous data set and an aggregated modeled data set, wherein the aggregated previous data set is generated using the filtered previous data, and wherein the aggregated modeled data set is generated using the filtered modeled data;
generating an aggregate prediction using the aggregated data set; and
reconciling the aggregate prediction and the aggregated modeled data set to determine prediction statistics for the aggregate prediction.

9. The computer program product of claim 8, wherein previous data includes a sequence of measured data values made over a previous time interval.

10. The computer program product of claim 8, wherein modeled data includes a sequence of modeled data values made over a previous time interval.

11. The computer program product of claim 10, wherein modeled data includes a sequence of summary statistics associated with the sequence of modeled data values.

12. The computer program product of claim 8, wherein identifying the aggregation type includes receiving input corresponding to determination of the aggregation type.

13. The computer program product of claim 8, wherein aggregating includes forming a single aggregated previous data set from the filtered previous data or wherein aggregating includes forming a single aggregated modeled data set from the filtered modeled data.

14. The computer program product of claim 8, wherein the aggregate prediction includes predicted data for an upcoming time interval.

15. A computer implemented method for generating an aggregate prediction, the method comprising:
identifying, at a computing device, a plurality of data sets, wherein the plurality of data sets includes previous data, modeled data, and one or more data set attributes;
receiving a filter criterion for filtering the plurality of data sets based on the data set attributes;
filtering the plurality of data sets using the filter criterion to identify a filtered plurality of data sets that is a subset of the plurality of data sets, wherein each filtered data set has one or more data set attributes that are associated with the filter criterion, and wherein a filtered data set includes filtered previous data and filtered modeled data;
identifying an aggregation type, wherein the aggregation type identifies how the filtered plurality of data sets are to be aggregated;
generating an aggregated data set, wherein generating includes aggregating the filtered plurality of data sets using the aggregation type, wherein the aggregated data set includes an aggregated previous data set and an aggregated modeled data set, wherein the aggregated previous data set is generated using the filtered previous data, and wherein the aggregated modeled data set is generated using the filtered modeled data;
generating an aggregate prediction using the aggregated data set; and
reconciling the aggregate prediction and the aggregated modeled data set to determine summary statistics for the aggregate prediction.

16. The method of claim 15, wherein previous data includes a sequence of measured data values made over a previous time interval.

17. The method of claim 15, wherein modeled data includes a sequence of modeled data values made over a previous time interval.

18. The method of claim 17, wherein modeled data includes a sequence of summary statistics associated with the sequence of modeled data values.

19. The method of claim 15, wherein identifying the aggregation type includes receiving input corresponding to determination of the aggregation type.

20. The method of claim 15, wherein aggregating includes forming a single aggregated previous data set from the filtered previous data or wherein aggregating includes forming a single aggregated modeled data set from the filtered modeled data.

21. The method of claim 15, wherein the aggregate prediction includes predicted data for an upcoming time interval.
